(19) United States
(12) Patent Application Publication
(10) Pub. No.: US 2026/0079840 A1
(43) Pub. Date: Mar. 19, 2026

(54) DIRTY TRACKING BIT COMPRESSION

(71) Applicant: ADVANCED MICRO DEVICES, INC., Santa Clara, CA (US)

(72) Inventors: Alistair James Shaun Symonds, Boxborough, MA (US); Jeffrey C. Allan, Boxborough, MA (US)

(21) Appl. No.: 18/890,178

(22) Filed: Sep. 19, 2024

(51) Int. Cl. G06F 12/123; G06F 12/0871; G06F 12/0891

(52) U.S. Cl. CPC G06F 12/0804; G06F 12/0871; G06F 12/0891

(57) ABSTRACT

A cache controller of a cache assigns a dirty tracking bit for each dirty byte of a cache line. Once a predetermined interval has elapsed without any accesses to the cache line or to a cache set that includes the cache line, the cache controller compresses contiguous dirty tracking bits for each portion of the cache line. Compressing the dirty tracking bits for contiguous dirty portions of the cache line allows the cache to store more dirty data using fewer dirty tracking bits, reducing area cost and bandwidth among levels of a memory hierarchy.

### BACKGROUND

Processing systems implement a memory hierarchy that uses a hierarchy of one or more caches of varying speeds to store frequently accessed data and a system memory. Data that is requested more frequently is typically cached in a relatively high-speed cache (such as an L1 cache) that is deployed physically (or logically) closer to a processor core or compute unit. Higher-level caches (such as an L2 cache, an L3 cache, and the like) store data that is requested less frequently. A last level cache (LLC) is the highest level (and lowest access speed) cache and the LLC reads data directly from system memory and writes data directly to the system memory. Caches differ from memories because they implement a cache replacement policy to replace the data in a cache entry in response to new data needing to be written to the cache. For example, a least-recently-used (LRU) policy replaces a cache line that has not been accessed for the longest time interval by evicting the data in the LRU cache line and writing new data to the LRU cache line. Thus, the cache hierarchy used to cache data for a processor periodically evicts modified data that has not been propagated to other levels of the cache hierarchy (referred to herein as “dirty data”) from the caches. To maintain coherency among the caches of the cache hierarchy, dirty bytes of each cache line stored at the cache are tracked.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system configured to compress dirty tracking bits at configurable granularity levels in accordance with some embodiments.

FIG. 2 is a block diagram of a cache controller compressing dirty tracking bits at configurable granularity levels in accordance with some embodiments.

FIG. 3 is a block diagram of configurable granularity levels for dirty tracking bit compression based on cache traffic patterns in accordance with some embodiments.

FIG. 4 is a flow diagram illustrating a method for compressing dirty tracking bits at configurable granularity levels in accordance with some embodiments.

### DETAILED DESCRIPTION

Typically, to maintain coherency with a cache hierarchy, a tracking bit (referred to herein as a dirty tracking bit) is assigned to each dirty byte of each cache line stored at a cache. Tracking dirty bytes of cache lines stored at the cache thus consumes overhead in the form of the dirty tracking bits. For example, to support fully dirty cache tracking, in which every byte of every cache line stored at the cache is dirty, the cache or an associated memory structure is sized to accommodate a dirty tracking bit for each byte stored at the cache. Thus, a cache having data storage for 32 kilobytes also conventionally requires storage for 4 kilobytes of dirty tracking bits to support fully dirty cache tracking. However, some applications generate cache traffic patterns that result in a processor writing to large portions of a cache line or to an entire cache line. If the cache or an associated memory structure is limited to less than one dirty tracking bit per byte of data stored at the cache, the cache controller may have to write back dirty data to other levels of the memory hierarchy if insufficient dirty tracking bits are available to track the dirty data at the cache. Writing the dirty data back to other levels of the memory hierarchy consumes bandwidth both for the write back and for subsequent retrievals of the cache line from other levels of the memory hierarchy.

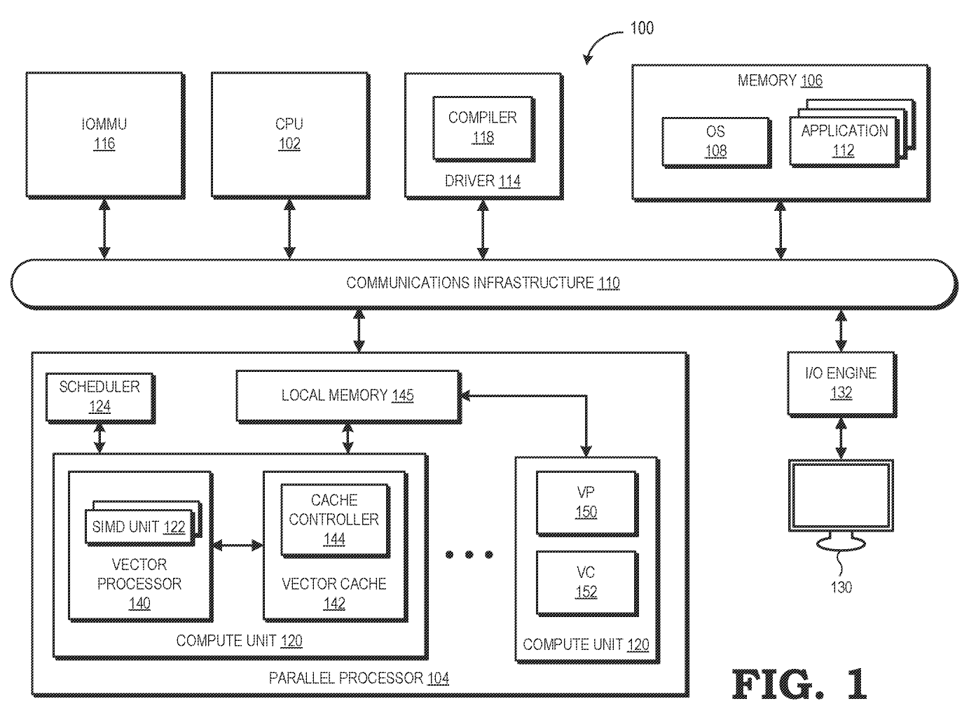

To reduce the amount of memory (i.e., area cost) associated with tracking dirty data at a cache, FIGS. 1-4 illustrate techniques for compressing dirty tracking bits for contiguous modified portions of a cache line at configurable granularity levels. In embodiments described herein, a cache controller of a cache assigns a dirty tracking bit for each dirty byte of a cache line and compresses contiguous dirty tracking bits for each portion of the cache line prior to evicting the cache line from the cache. In some implementations, the cache controller sets the size of each portion of the cache line based on traffic patterns to the cache. For example, if traffic patterns to the cache indicate that a processor associated with the cache is frequently writing data in four-byte (i.e., DWORD) chunks to the cache, the cache controller sets the size of each portion of each cache line stored at the cache (i.e., the granularity level of dirty bit tracking) to four bytes. If four contiguous bytes of a cache line, starting from a DWORD boundary of the cache line, are dirty, the cache controller compresses the four dirty tracking bits for the four contiguous dirty bytes to a single dirty tracking bit for the DWORD and sets a flag for the dirty tracking bits indicating that the dirty tracking bits are compressed on a DWORD basis. If the entire cache line is dirty, the cache controller compresses the assigned dirty tracking bits to a single compressed dirty bit and sets a flag indicating that the single compressed dirty bit encompasses the entire cache line. Thus, whereas a 128-byte cache line formerly required 128 dirty tracking bits to indicate that the entire cache line was dirty, using the techniques described herein, a single dirty tracking bit is used to indicate that the entire cache line is dirty.

In some implementations, while the cache line resides in the cache and is therefore subject to further modification before being evicted, the cache controller maintains dirty tracking on a per-byte basis. Once a predetermined interval has elapsed, such as an amount of time or a number of accesses to the cache, without any accesses to the cache line or, in some implementations, to a set of the cache to which the cache line belongs, the cache controller compresses contiguous dirty tracking bits for each portion of the cache line. Compressing the dirty tracking bits for contiguous dirty portions of the cache line allows the cache to store more dirty data using fewer dirty tracking bits, reducing area cost and bandwidth among caches of the cache hierarchy.

The techniques described herein are, in different embodiments, employed at any of a variety of parallel processors (e.g., accelerated processing units (APUs), vector processors, graphics processing units (GPUs), general-purpose GPUs (GPGPUs), non-scalar processors, highly-parallel processors, artificial intelligence (AI) processors, neural network (NN) accelerators, inference engines, machine learning processors, other multithreaded processing units, and the like). FIG. 1 illustrates an example of a processing system 100 including a central processing unit (CPU) 102 and a parallel processor 104, in accordance with some embodiments. In at least some embodiments, the processing system 100 is a computer, laptop/notebook, mobile device, gaming device, wearable computing device, server, or any of various other types of computing systems or devices. It is noted that the number of components of the processing system 100 varies from embodiment to embodiment. In at least some embodiments, there is more or fewer of each component/subcomponent than the number shown in FIG. 1. It is also noted that the processing system 100, in at least some embodiments, includes other components not shown in FIG. 1. Additionally, in other embodiments, the processing system 100 is structured in other ways than shown in FIG. 1.

The parallel processor 104 includes a plurality of compute units (CU) 120 that execute instructions concurrently or in parallel. In some embodiments, each one of the CUs 120 includes one or more single instruction, multiple data (SIMD) units, and the CUs 120 are aggregated into workgroup processors, shader arrays, shader engines, or the like. The number of CUs 120 implemented in the parallel processor 104 is a matter of design choice and some embodiments of the parallel processor 104 include more or fewer compute units than shown in FIG. 1. In some embodiments, the parallel processor 104 is used for general purpose computing. In various embodiments, the parallel processor 104 includes any cooperating collection of hardware and or software that perform functions and computations associated with accelerating graphics processing tasks, data-parallel tasks, nested data-parallel tasks in an accelerated manner with respect to resources such as conventional central processing units (CPUs), conventional graphics processing units (GPUs), and combinations thereof.

As illustrated in FIG. 1, the processing system 100 also includes a system memory 106, an operating system 108, a communications infrastructure 110, and one or more applications 112. Access to the system memory 106 is managed by a memory controller (not shown) coupled to system memory 106. For example, requests from the CPU 102 or other devices for reading from or for writing to the system memory 106 are managed by the memory controller. In some embodiments, the one or more applications include various programs or commands to perform computations that are also executed at the CPU 102. The CPU 102 sends selected commands for processing at the parallel processor 104. The parallel processor 104 executes instructions such as program code of one or more applications 112 stored in the system memory 106 and the parallel processor 104 stores information in the system memory 106 such as the results of the executed instructions.

The operating system 108 and the communications infrastructure 110 are discussed in greater detail below. The processing system 100 further includes a driver 114 and a memory management unit, such as an input/output memory management unit (IOMMU) 116. Components of the processing system 100 are implemented as hardware, firmware, software, or any combination thereof. In some embodiments, the processing system 100 includes one or more software, hardware, and firmware components in addition to or different from those shown in FIG. 1.

Within the processing system 100, the system memory 106 includes non-persistent memory, such as DRAM (not shown). In various embodiments, the system memory 106 stores processing logic instructions, constant values, variable values during execution of portions of applications or other processing logic, or other desired information. For example, in various embodiments, parts of control logic to perform one or more operations on the CPU 102 reside within the system memory 106 during execution of the respective portions of the operation by the CPU 102. During execution, respective applications, operating system functions, processing logic commands, and system software reside in the system memory 106. Control logic commands that are fundamental to the operating system 108 generally reside in the system memory 106 during execution. In some embodiments, other software commands (e.g., a set of instructions or commands used to implement the device driver 114) also reside in the system memory 106 during execution by the processing system 100.

The IOMMU 116 is a multi-context memory management unit. As used herein, context is considered the environment within which kernels execute and the domain in which synchronization and memory management is defined. The context includes a set of devices, the memory accessible to those devices, the corresponding memory properties, and one or more command-queues used to schedule execution of a kernel(s) or operations on memory objects. The IOMMU 116 includes logic to perform virtual to physical address translation for memory page access for devices, such as the parallel processor 104. In some embodiments, the IOMMU 116 also includes, or has access to, a translation lookaside buffer (TLB) (not shown). The TLB is implemented in a content addressable memory (CAM) to accelerate translation of logical (i.e., virtual) memory addresses to physical memory addresses for requests made by the parallel processor 104 for data in the system memory 106.

In various embodiments, the communications infrastructure 110 interconnects the components of the processing system 100. The communications infrastructure 110 includes (not shown) one or more of a peripheral component interconnect (PCI) bus, extended PCI (PCI-e) bus, advanced microcontroller bus architecture (AMBA) bus, advanced graphics port (AGP), or other such communication infrastructure and interconnects. In some embodiments, the communications infrastructure 110 also includes an Ethernet network or any other suitable physical communications infrastructure that satisfies an application’s data transfer rate requirements. The communications infrastructure 110 also includes the functionality to interconnect components, including components of the processing system 100.

A driver 114 communicates with a device (e.g., parallel processor 104) through an interconnect or the communications infrastructure 110. When a calling program invokes a routine in the driver 114, the driver 114 issues commands to the device. Once the device sends data back to the driver 114, the driver 114 invokes routines in an original calling program. In general, drivers are hardware-dependent and operating-system-specific to provide interrupt handling required for any necessary asynchronous time-dependent hardware interface. In some embodiments, a compiler 118 is embedded within the driver 114. The compiler 118 compiles source code into program instructions as needed for execution by the processing system 100. During such compilation, the compiler 118 applies transforms to program instructions at various phases of compilation. In other embodiments, the compiler 118 is a standalone application. In various embodiments, the driver 114 controls operation of the parallel processor 104 by, for example, providing an application programming interface (API) to software (e.g., applications) executing at the CPU 102 to access various functionality of the parallel processor 104.

The CPU 102, in at least some embodiments, includes one or more single- or multi-core CPUs. The CPU 102 includes (not shown) one or more of a control processor, field- programmable gate array (FPGA), application-specific integrated circuit (ASIC), or digital signal processor (DSP). The CPU 102 executes at least a portion of the control logic that controls the operation of the processing system 100. For example, in various embodiments, the CPU 102 executes the operating system 108, the one or more applications 112, and the driver 114. In some embodiments, the CPU 102 initiates and controls the execution of the one or more applications 112 by distributing the processing associated with one or more applications across the CPU 102 and other processing resources, such as the parallel processor 104.

The parallel processor 104 executes commands and programs for selected functions, such as vector processing operations and other operations that are particularly suited for parallel processing. In general, the parallel processor 104 is frequently used for executing graphics pipeline operations, such as pixel operations, geometric computations, and rendering an image to a display. In some embodiments, the parallel processor 104 also executes compute processing operations (e.g., those operations unrelated to graphics such as video operations, physics simulations, computational fluid dynamics, etc.), based on commands or instructions received from the CPU 102. For example, such commands include special instructions that are not typically defined in the instruction set architecture (ISA) of the parallel processor 104.

The SIMD execution model is one in which multiple processing elements share a single program control flow unit and program counter and thus execute the same program but are able to execute that program with different data. The number of compute units 120 implemented in the parallel processor 104 is configurable. Each compute unit 120 includes one or more processing elements such as scalar and or vector floating-point units (referred to herein as scalar processors and vector processors, respectively), arithmetic and logic units (ALUs), and the like. In various embodiments, the compute units 120 also include special-purpose processing units (not shown), such as inverse-square root units and sine/cosine units.

Each of the one or more compute units 120 executes a respective instantiation of a particular work item to process incoming data, where the basic unit of execution in the one or more compute units 120 is a work item (e.g., a thread). Each work item represents a single instantiation of, for example, a collection of parallel executions of a kernel invoked on a device by a command that is to be executed in parallel. A work item executes at one or more processing elements as part of a workgroup executing at a compute unit 120.

The parallel processor 104 issues and executes work-items, such as groups of threads executed simultaneously as a “wave”, on a single SIMD unit 122. Waves, in at least some embodiments, are interchangeably referred to as wavefronts, warps, vectors, or threads. In some embodiments, waves include instances of parallel execution of a shader program, where each wave includes multiple work items that execute simultaneously on a single SIMD unit 122 in line with the SIMD paradigm (e.g., one instruction control unit executing the same stream of instructions with multiple data). A scheduler 124 is configured to perform operations related to scheduling various waves on different CUs 120 and SIMD units 122 and performing other operations to orchestrate various tasks on the parallel processor 104.

In some embodiments, the processing system 100 includes input/output (I/O) engine 132 that includes circuitry to handle input or output operations associated with display 130, as well as other elements of the processing system 100 such as keyboards, mice, printers, external disks, and the like. The I/O engine 132 is coupled to the communications infrastructure 110 so that the I/O engine 132 communicates with the system memory 106, the parallel processor 104, and the CPU 102. In some embodiments, the CPU 102 issues one or more draw calls or other commands to the parallel processor 104. In response to the commands, the parallel processor 104 schedules, via the scheduler 124, one or more operations at the compute units 120. In some embodiments, based on the operations, the parallel processor 104 generates a rendered frame, and provides the rendered frame to the display 130 via the I/O engine 132.

The parallelism afforded by the one or more compute units 120 is suitable for general purpose compute and tensor operations. The scheduler 124 issues work to the compute units 120 to perform general purpose computation tasks, such as operations to accelerate the calculation of tensor operations, for execution in parallel. Some parallel computation operations require that the same command stream or compute kernel be performed on streams or collections of input data elements. Respective instantiations of the same compute kernel are executed concurrently on multiple SIMD units 122 in the one or more compute units 120 to process such data elements in parallel. As referred to herein, for example, a compute kernel is a function containing instructions declared in a program and executed on parallel processor compute unit 120.

In some embodiments, each compute unit 120 includes a vector processor 140, 150 and a vector cache 142, 152, allowing for versatile processing capabilities such as handling arrays of data elements at the vector processor within a single compute unit 120. The vector processors 140, 150 are configured to perform vector arithmetic, including permute functions, pre-addition functions, multiplication functions, post-addition functions, accumulation functions, shift, round and saturate functions, upshift functions, and the like. The vector processors 140, 150 support multiple precisions for complex and real operands. The vector processors 140, 150 can include both fixed-point and floating-point data paths.

To reduce latency associated with off-chip memory access, various parallel processor architectures include a local memory 145 implemented as, e.g., a memory cache hierarchy including, for example, L1 cache and a local data share (LDS) such as vector caches 142, 152. The vector caches 142, 152 are high-speed, low-latency memories private to each compute unit 120. In some embodiments, the LDS is a full gather/scatter model so that a workgroup writes anywhere in an allocated space.

To reduce the overhead and bandwidth associated with tracking modified data at the vector caches 142, 152 that has not been propagated to other levels of the memory hierarchy, a cache controller such as cache controller 144 associated with each of the vector caches 142, 152 tracks dirty data at the vector caches 142, 152 at a configurable granularity level based on traffic patterns to the vector caches 142, 152. For example, if traffic patterns indicate that the vector processor 140 frequently writes (i.e., modifies) data at the vector cache 142 in DWORD-sized increments, the cache controller 144 sets a portion size for cache lines stored at the vector cache 142 to a DWORD, or four bytes. While a cache line is resident in the vector cache 142, the cache controller tracks modifications to the cache line on a per-byte basis by assigning a dirty tracking bit to each dirty byte of the cache line. Before the cache line is evicted from the vector cache 142, the cache controller 144 compresses contiguous dirty tracking bits (corresponding to contiguous dirty bytes of the cache line) for each portion of the cache line. Thus, for example, if the portion size is a DWORD and four contiguous bytes of data within the cache line starting at a DWORD boundary are dirty, the cache controller 144 compresses the four contiguous dirty tracking bits corresponding to the four contiguous dirty bytes into a single dirty tracking bit and indicates (e.g., with a flag) that the dirty bit tracking is on a per-DWORD basis. In another example, if the entire cache line is dirty before being evicted from the vector cache 142, the cache controller compresses the per-byte dirty tracking bits into a single compressed dirty tracking bit for the cache line and indicates that the dirty tracking bit is on a per-cache line basis.

In some embodiments, the dirty tracking bits for a cache line are referred to as a dirty mask. While the cache line is resident in the vector cache 142, the cache line is subject to further writes by the vector processor 140, such that the dirty mask is subject to change. In some implementations, to free up dirty tracking bits while cache lines are pending further writes, the cache controller 144 periodically compresses contiguous dirty tracking bits for each portion of the cache lines, for example, once a predetermined interval has elapsed without the cache line (or a cache set to which the cache line belongs) being accessed. If the cache line is subsequently accessed by the vector processor 140, the cache controller 144 decompresses the dirty mask to indicate modified data on a per-byte basis. Following the access, and after another predetermined interval has elapsed without the cache line (or cache set) being accessed, the cache controller 144 again compresses the contiguous dirty tracking bits of the dirty mask on a per-portion basis.

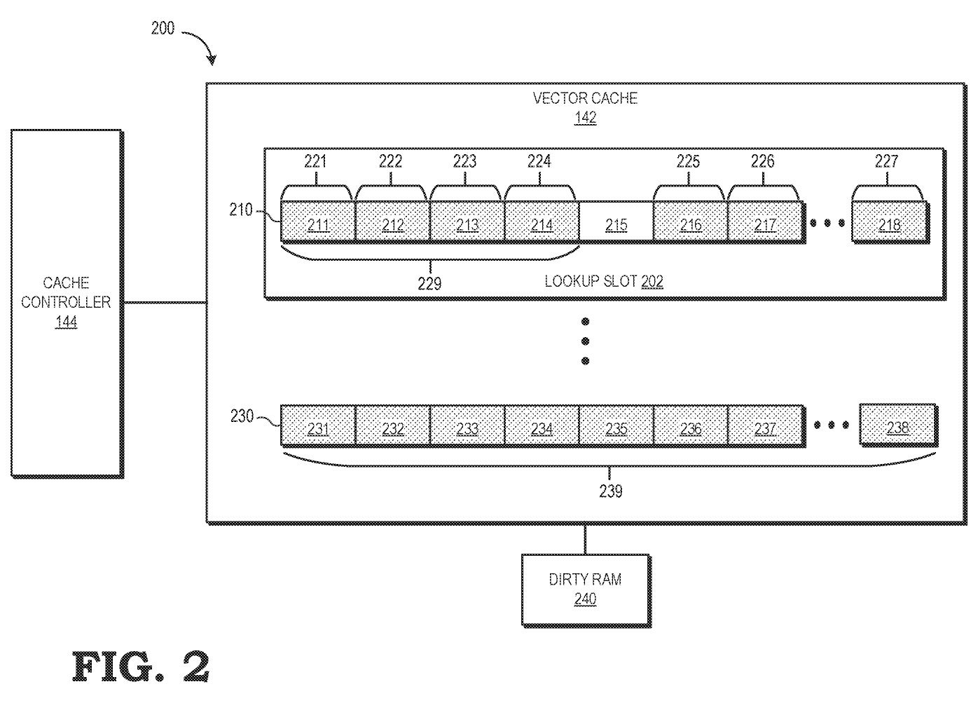

FIG. 2 is a block diagram 200 of a cache controller such as cache controller 144 of a cache such as vector cache 142 compressing dirty tracking bits at configurable granularity levels in accordance with some embodiments. In the illustrated example, the vector cache 142 stores a plurality of cache lines including cache lines 210, 230, and is associated with a dirty RAM 240 which is a random access memory that stores dirty bits for cache lines stored at the vector cache 142 that include modified data that has not been propagated to other levels of the memory hierarchy (i.e., dirty masks). The dirty RAM 240 is sized in some implementations to hold dirty masks to accommodate up to a threshold percentage (e.g., 10%) of the cache lines stored at the vector cache 142 being sparsely dirty (i.e., having dirty bits to track modified data on a per-byte basis).

The vector cache 142 includes a lookup slot 202 that stores cache lines that are the subject of a current cache request. When a cache line, such as cache line 210, which includes bytes 211-218, is the subject of a cache request, the cache line 210 is placed in the lookup slot 202 and a dirty mask for the cache line 210 is retrieved from the dirty RAM 240. If the dirty mask was previously compressed, the dirty mask is decompressed while the cache line 210 is in the lookup slot 202 so that each dirty byte of the cache line 210 is identified by a dirty bit. After the vector processor 142 has accessed the cache line 210, any additional writes to bytes of the cache line 210 are recorded with a dirty bit. Thus, in the illustrated example, following an access to the cache line 210 by the vector processor 140, bytes 211, 212, 213, 214, 216, 217, and 218 are dirty and the cache controller 144 assigns a dirty bit (i.e., dirty bits 221, 222, 223, 224, 225, 226, and 227) to each.

To reduce the number of dirty tracking bits that are used to track modified data, the cache controller 144 compresses contiguous dirty bits assigned to the cache line 210 for each portion of the cache line 210. The cache controller 144 sets the size of each portion of the cache line 210 based on traffic patterns to the vector cache 142 in some implementations. For example, if the traffic patterns indicate that the vector processor 140 tends to write DWORD-sized chunks of data to the vector cache 142, in some implementations the cache controller 144 sets the portion size of the cache lines stored at the vector cache 142 to 4 bytes (i.e., one DWORD). Because the dirty bytes 211, 212, 213, and 214 begin at a DWORD boundary of the cache line 210, are contiguous, and fill a portion (DWORD) of the cache line 210, the cache controller 144 compresses the assigned dirty bits 221, 222, 223, and 224 into a single compressed dirty bit 229. In some implementations, the cache controller 144 indicates, e.g., with a flag, the range of portions of the cache line 210 that are represented by the compressed dirty bit 229. For example, the compressed dirty bit 229 is accompanied by a flag indicating that the portion size for dirty bit compression is a DWORD. The remainder of the cache line 210 is sparsely dirty (i.e., does not contain any more contiguously dirty DWORDs), so the originally assigned dirty bits 225, 226, and 227 remain uncompressed. When the cache line 210 is rotated out of the lookup slot 202, the compressed dirty mask with dirty bits 229, 225, 226, and 227 is saved at the dirty RAM 240.

Cache line 230 has been rotated out of the lookup slot 202 and includes dirty bytes 231, 232, 233, 234, 235, 236, 237, and 238. In the illustrated example, cache line 230 includes only dirty bytes. Because cache line 230 includes only dirty bytes, the cache controller 144 assigns a dirty bit (not shown) to each dirty byte 231-238 and compresses the contiguous dirty bits into a single compressed dirty bit 239. The cache controller 144 indicates, e.g., with a flag (not shown), that the range of portions of the cache line 230 that are represented by the compressed dirty bit 239 includes the entire cache line 230. By compressing the dirty bits into the single compressed dirty bit 239 for the entire cache line 230, the cache controller 144 significantly reduces the number of dirty bits assigned to the cache line 230. For example, although in the illustrated example cache line 230 includes only 8 bytes, such that the number of dirty bits is reduced from 8 to 1, in other implementations a cache line includes, e.g., 128 bytes, such that the number of dirty bits is reduced from 128 to 1.

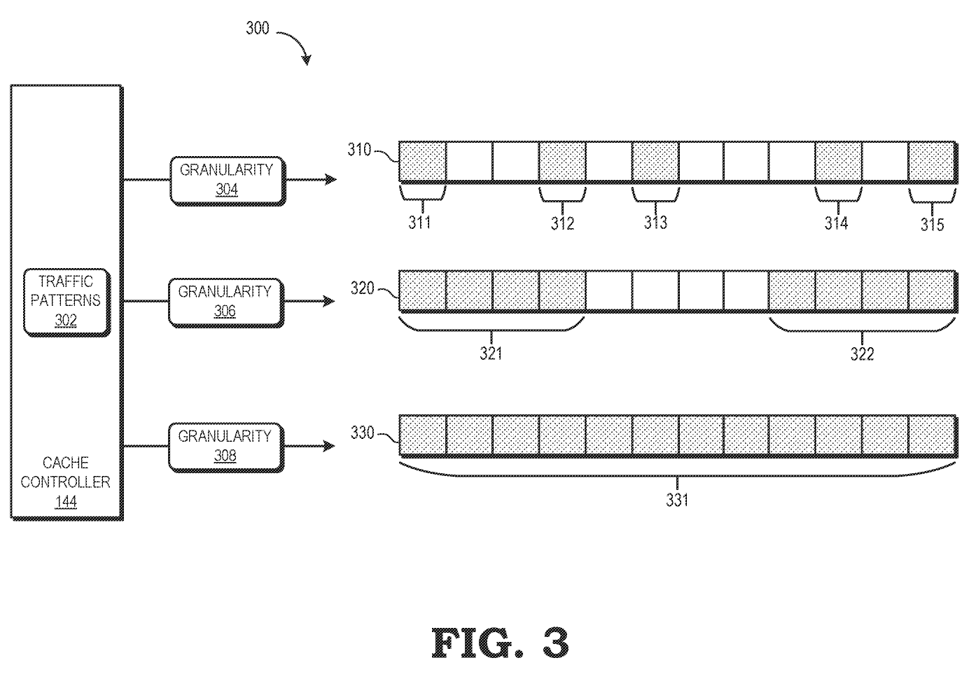

FIG. 3 is a block diagram 300 of configurable granularity levels for dirty tracking bit compression based on cache traffic patterns in accordance with some embodiments. In the illustrated example, the cache controller 144 analyzes traffic patterns 302 to the vector cache 142 and sets a granularity level (i.e., portion size of cache lines) for dirty tracking bit compression based on the traffic patterns 302.

If the traffic patterns 302 indicate that the vector processor 140 is sparsely writing to the vector cache 142, the cache controller 144 applies a high granularity 304, in which a dirty bit is assigned for each dirty byte of a cache line and no dirty bit compression is performed. For example, cache line 310 is sparsely dirty, with no contiguous dirty bytes. Accordingly, the cache controller 144 assigns dirty bits 311, 312, 313, 314, and 315 to the dirty bytes of cache line 310 and does not compress the dirty bits.

If the traffic patterns 302 indicate that the vector processor 140 is writing to the vector cache 142 in 4-byte chunks, the cache controller 144 applies a DWORD granularity 306, in which a dirty bit is assigned for each dirty byte of a cache line and dirty bit compression is performed on a DWORD basis. For example, cache line 320 includes 12 bytes, the first and last four of which are dirty. The cache controller 144 assigns dirty bits (not shown) to each of the first and last four bytes (i.e., 8 dirty bits) and compresses the first four dirty bits into a single compressed dirty bit 321 and compresses the last four dirty bits into a single compressed dirty bit 322. The cache controller 144 indicates with a flag that the dirty bit compression is on a DWORD basis.

If the traffic patterns 302 indicate that the vector processor 140 is writing to the vector cache 142 in full cache line chunks, the cache controller applies a full cache line granularity 308, in which a dirty bit is assigned for each dirty byte of a cache line and dirty bit compression is performed on a full cache line basis. For example, every byte of cache line 330 is dirty. The cache controller 144 assigns dirty bits (not shown) to each byte of the cache line 330 and compresses all the dirty bits into a single compressed dirty bit 331. The cache controller 144 indicates with a flag that the dirty bit compression is on a cache line basis.

In other implementations, the cache controller 144 sets the granularity level to a different portion size based on the traffic patterns 302. For example, if the vector processor 140 performs a significant amount of double precision operations, the cache controller 144 may set the granularity level to 8 bytes, or two DWORDS.

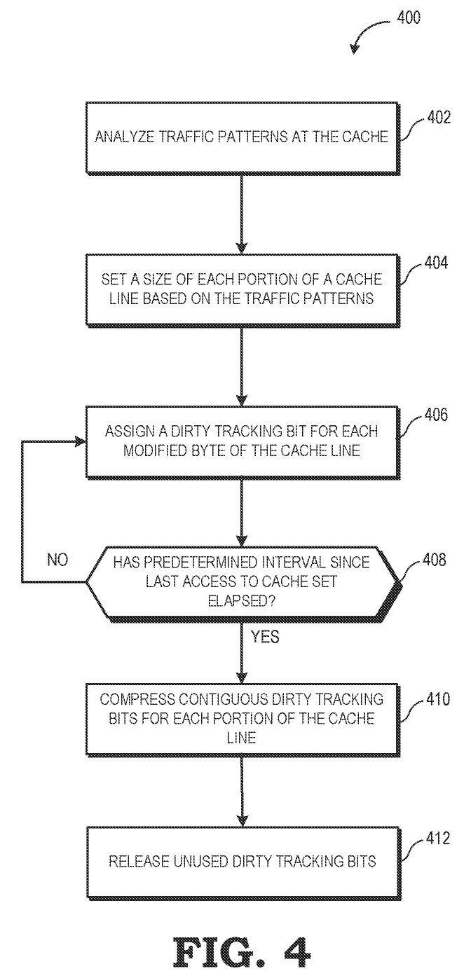

FIG. 4 is a flow diagram illustrating a method 400 for compressing dirty tracking bits at configurable granularity levels in accordance with some embodiments. In some embodiments, the method 400 is implemented at a processing system such as processing system 100.

At block 402, a cache controller such as cache controller 144 analyzes traffic patterns such as traffic patterns 302 at a cache such as the vector cache 142 in some embodiments. For example, a traffic pattern 302 may indicate that the vector processor 140 is writing multiple DWORDs to the vector cache 142.

At block 404, the cache controller 144 sets a size of each portion of a cache line based on the traffic patterns 302. Thus, if the traffic pattern 302 indicates that the vector processor 140 is writing multiple DWORDs to the vector cache 142, the cache controller 144 sets the size of each portion of the cache line to a DWORD. In another example, if the traffic pattern 302 indicates that the vector processor 140 is performing double precision math operations and writing to the vector cache 142 in 8-byte chunks, the cache controller 144 sets the size of each portion of the cache line to 8 bytes.

At block 406, the cache controller 144 assigns a dirty tracking bit to each modified byte of a cache line stored at the vector cache 142 that has not been propagated to other levels of the memory hierarchy. In some embodiments, the cache controller 144 assigns the dirty tracking bits while the cache line is resident at a lookup slot such as lookup slot 202 of the vector cache 142 (i.e., while the cache line is subject to a cache access request by the vector processor 140).

The method flow then proceeds to block 408, at which the cache controller 144 determines whether a predetermined interval has elapsed since the most recent access request targeting the cache line or, in some embodiments, a cache set to which the cache line belongs. In some implementations, the predetermined interval is based on a predetermined amount of time and in other implementations, the predetermined interval is based on a number of accesses to the vector cache 142.

If the predetermined interval has not yet elapsed, the method flow returns to block 406, such that the cache controller continues assigning dirty tracking bits on a per-byte basis as the cache line remains resident in the vector cache 142 and is further modified by writes by the vector processor 140. If the predetermined interval has elapsed, the method flow continues to block 410.

At block 410, the cache controller 144 compresses dirty tracking bits for each portion of the cache line. Thus, for example, if the portion size is set to one DWORD, the cache controller 144 compresses every four contiguous dirty tracking bits that align with a DWORD boundary of the cache line into a single compressed dirty tracking bit. In some embodiments, the cache controller sets a flag for the compressed dirty tracking bit indicating that the compressed dirty tracking bit represents a DWORD range of dirty bytes of the cache line. In another example, if the entire cache line is dirty, the cache controller 144 compresses the dirty tracking bits for each byte of the cache line into a single compressed dirty tracking bit and sets a flag indicating that the compressed dirty tracking bit represents a cache line range of dirty bytes of the cache line (i.e., that the entire cache line is dirty).

At block 412, the cache controller 144 releases any unused dirty tracking bits (i.e., dirty tracking bits that were compressed and are no longer needed to track dirty bytes of a cache line) to the dirty RAM 240. By compressing the dirty tracking bits on a per-portion or per-cache line basis, the cache controller 144 is able to track more dirty data in the vector cache 142 using fewer dirty tracking bits, thus lowering the overhead and allowing more dirty data to be stored at the vector cache 142. By allowing more dirty data to be stored at the vector cache 142, the cache controller 144 reduces the bandwidth consumed in writing dirty data back to other levels of the memory hierarchy, thus improving processing efficiency.

In some embodiments, the apparatus and techniques described above are implemented in a system including one or more integrated circuit (IC) devices (also referred to as integrated circuit packages or microchips), such as the processing system described above with reference to FIGS. 1-4. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry, etc.) are described or claimed as “configured” to perform one or more tasks or operations. This formulation—[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
assigning a dirty tracking bit for each byte of a cache line that is modified while the cache line is stored at a cache and not yet propagated to another cache or memory; and
compressing contiguous dirty tracking bits for each portion of a plurality of portions of the cache line prior to evicting the cache line from the cache.

2. The method of claim 1, further comprising:
setting a size of each portion of the plurality of portions of the cache line based on traffic patterns to the cache.

3. The method of claim 2, wherein the size of each portion is 4 bytes.

4. The method of claim 1, wherein the cache line is one of a plurality of cache lines of a set stored at the cache and compressing is performed after the set has not been accessed for a predetermined interval.

5. The method of claim 4, wherein the predetermined interval is based on a number of accesses to the cache.

6. The method of claim 1, wherein each compressed dirty tracking bit indicates a range of one or more portions of the cache line that are modified.

7. The method of claim 6, further comprising:
indicating with a single compressed dirty tracking bit that all portions of the cache line are modified.

8. A device, comprising:
a cache; and
a cache controller configured to:
assign a dirty tracking bit for each byte of a cache line that is modified while the cache line is stored at the cache; and
compress contiguous dirty tracking bits for each portion of a plurality of portions of the cache line prior to evicting the cache line from the cache.

9. The device of claim 8, wherein the cache controller is further configured to:
set a size of each portion of the plurality of portions of the cache line based on traffic patterns to the cache.

10. The device of claim 9, wherein the size of each portion is 4 bytes.

11. The device of claim 8, wherein the cache controller is further configured to:
compress the contiguous dirty tracking bits after a set of cache lines comprising the cache line has not been accessed for a predetermined interval.

12. The device of claim 11, wherein the predetermined interval is based on a number of accesses to the cache.

13. The device of claim 12, wherein each compressed dirty tracking bit indicates a range of one or more portions of the cache line that are modified.

14. The device of claim 13, wherein the cache controller is further configured to:
indicate with a single compressed dirty tracking bit that all portions of the cache line are modified.

15. A system, comprising:
a processor;
a cache; and
a cache controller configured to:
allocate a dirty mask comprising one or more dirty tracking bits to indicate modified bytes of a cache line stored at the cache; and
compress contiguous dirty tracking bits of the dirty mask corresponding to contiguous modified portions of the cache line into a single dirty tracking bit indicating a contiguous range of modified portions of the cache line prior to evicting the cache line from the cache.

16. The system of claim 15, wherein the cache controller is further configured to:
set a size of each portion of the cache line based on traffic patterns to the cache.

17. The system of claim 16, wherein the size of each portion is 4 bytes.

18. The system of claim 15, wherein the cache controller is further configured to:
compress the contiguous dirty tracking bits after a set of cache lines comprising the cache line has not been accessed for a predetermined interval.

19. The system of claim 18, wherein the predetermined interval is based on a number of accesses to the cache.

20. The system of claim 15, wherein the cache controller is further configured to:
indicate with a single compressed dirty tracking bit that all portions of the cache line are modified.
